(19) United States
(12) Patent Application Publication
(10) Pub. No.: US 2003/0040932 A1
(43) Pub. Date: Feb. 27, 2003

(54) Management device, method and system

(76) Inventor: Kazuhiko Sato, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/190,339

(22) Filed: Jul. 3, 2002

(30) Foreign Application Priority Data
Aug. 23, 2001 (JP) 2001-253457

(51) Int. Cl. G06F 17/60

(52) U.S. Cl. 705/1

(57) ABSTRACT

A management system comprises a managed device, located in a managed area, wherein the managed device can be connected to a network and assigned network information that enables the managed device to communicate over the network. The management system further comprises a guard manager, configured to guard the managed area against unauthorized access, and a management device, which manages the guard manager and uses the network information of the managed device to manage the managed device. The management system can provide a variety of security levels in managing the managed area, and can read access information from an information recordable medium to allow access to the managed area and modification of the security level of the managed area.

### BACKGROUND OF THE INVENTION

1. Field of the Invention

The present invention relates to management systems, and more particularly to management systems that manage admittance to a predefined area.

2. Description of the Related Technology

Along with the recent increased number of Internet users, some apartment buildings have readily provided their tenants and residents (“residents” hereinafter) with Internet access. Such an apartment building allows a resident to access the Internet when he/she connects his/her network device, such as a personal computer (“PC”), to a network, such as a LAN, constructed in the apartment building (or to its subnet through an interconnecting device, such as a hub, a switch, or a router). This Internet environment typically uses a management device (also called “manager” or “server”) to monitor connection statuses and traffic of residents' network devices for the centralized management to the network.

However, it has generally been difficult to realize highly secured, unitary, and comprehensive management of the apartment building equipped with such a network. For example, a user at a network device, in accessing the network, is often required to enter a user ID and password, which is a combination of alphanumeric characters, so that the authentication may eliminate unauthorized person's access to maintain network security. Nevertheless, an unauthorized person may easily determine this combination because the user typically chooses his/her unforgettable information, such as a birthday, phone number, name, etc., for this combination.

In addition, due to unlawful entry and theft, enhanced housing security becomes substantially important in deterring intruders who attempt to steal money and valuables from an apartment. Some apartment buildings often hire a janitor or administrator for comprehensive management of the building, including crime prevention as well as maintenance of the apartment building, but the crime prevention becomes insufficient, for example, because the janitor is not at the building at night. Additionally, it becomes difficult for the janitor to provide sufficient management as the number of apartments increases in the apartment building, as described above. Thus, some residents inconveniently allocate housing security to an outside security company.

Thus, there is a need for a highly secured computer network system, which controls admittance to an area containing a device connectable to a network.

### SUMMARY OF CERTAIN INVENTIVE EMBODIMENTS

In order to achieve the above objects, a management system of one aspect of the invention includes a managed device, located in a managed area and connectable to a network. The managed device is assigned network information that allows the managed device to communicate in the network. The management system further comprises a guard manager configured to guard the managed area against an intrusion, and a management device that uses the network information of the managed device to manage the managed device and the guard manager. The management system allows the management device to manage the managed device and the guard manager, and thus provides unitary and comprehensive management for the network environment and the admittance to the managed area.

The network system may include a plurality of managed areas, managed devices, and guard managers, wherein one or more managed devices and at least one guard manager are located in each of the managed areas. This configuration is suitable for an apartment house, where the managed area is each apartment and a guard manager is provided for each apartment. In one embodiment, one guard manager guards a closed space including all of these managed areas, wherein the guard manager can be located at the entrance, lobby, and/or elevator in the apartment house.

The network information may include a communication parameter necessary for the managed device to communicate in the network, e.g., an IP address, a subnet mask, a default gateway, a user ID and password, or a combination thereof, and device information that defines the managed device, e.g., a MAC address and a housing identifier.

The management system may further include an interconnecting device that connects the managed and management devices to the network, wherein the management device configures the interconnecting device so that a different virtual local area network (VLAN) is assigned to each managed area based on the network information of the managed devices. According to this management system, the management device configures the interconnecting device and logically divides the network based on the network information of the managed devices, forming a plurality of groups of managed devices which can not communicate with each other even in the same network. Thereby, the management device may maintain a level of security for each VLAN group in the network. The network information may include an identifier of the VLAN.

Such an interconnecting device may execute a predefined operation when the drive unit reads predefined data from an information recordable medium. The predefined operation may include, for example, collection of predefined information and restriction of access to the network. This trigger function of the interconnecting device is advantageous so as to achieve an automated process.

The guard manager may have a plurality of operational modes corresponding to multiple security levels to guard the managed area. The guard manager can change the operational mode in response to receiving the network information from a person who attempts to enter the managed area, and in response to receiving the network information from a person who attempts to exit the managed area. Thereby, the management system may increase the security level when the user is out of the managed area. Of course, the management system may increase the security level even when the user is in the managed area, such as an apartment, for example, while the user is sleeping.

The management system may further include an entrance server that enables the managed device to access the network using the network information. The entrance server is effective, for example, when an intruder, e.g., a corporate spy, brings his notebook PC and intrudes the managed area, e.g., an office room, because the entrance server does not permit his PC to access the network due to the wrong network information.

A person who attempts to enter the managed area can use an information recordable medium to input information in the guard manager, wherein the guard manager includes a drive unit adapted to read the information from the information recordable medium, and wherein the guard manager allows the person to enter the managed area when the information read from the information recordable medium is the network information. This feature is advantageous where the person does not have to memorize the network information. The information recordable medium is, for example, an IC card.

Another aspect of the invention may include, for example, a storage part in the management device for storing the network information of the managed device, and a controller that uses the network information to control the managed device and the guard manager. The controller controls connection status and traffic of the managed device, wherein the guard manager controls admittance to the managed area using the network information, and the controller authenticates the network information for use with the guard manager. Either the controller or the guard manager may provide the authentication, but the controller preferably knows a result of authentication for security purposes. The controller may activate an alarm to inform a user of the management device that there is no correspondence between the information sent from the guard manager and the network information stored in the storage part, when the guard manager informs the controller of the intrusion upon the managed area. The controller may disconnect the managed device from the network, when the guard manager informs the management device that a user of the managed device is away from the managed area, so as to enhance the network security.

An additional aspect of the invention includes a guard manager connected to a management device that is connected to a network, wherein a managed device is located in a managed area and is connectable to the network, wherein the managed device is assigned network information that allows the managed device to communicate in the network, and wherein the management device uses the network information to manage the managed device and the guard manager. The guard manager comprises a reader configured to read information from an information recordable medium provided by a person who attempts to enter the managed area, a transmitter, connected to the management device, configured to transmit information read by the reader to the management device, and a controller configured to permit the person to enter the managed area when the management device directs it to do so. Thus, the guard manager, under control of the management device, promotes unitary management of the network environment and admittance into the managed area. Wherein the managed area has an entrance that opens and closes, the guard manager guards the managed area by locking and unlocking the (closed) entrance. Thus, the entrance may open when the guard manager unlocks the entrance.

The guard manager can include a sensor that detects intrusion upon the managed area, and the guard manager can inform the management device of an intrusion upon the managed area. In response, the management device may activate an alarm to alert its user, as described above.

According to another aspect of the present invention, there is provided a method of managing a managed device located in a managed area, and admittance into the managed area. The managed device is connectable to a network and assigned network information that allows the managed device to communicate in the network. The method comprises determining whether information provided by a person who attempts to enter the managed area is the network information, allowing the person to enter the managed area in response to determining that the information provided by the person is the network information, and managing a status of the managed device in the network using the network information. A program executing this method can be included on a computer readable medium such that a computer can execute the method. This method achieves highly secured, unitary and comprehensive management of the network environment and admittance to the managed area. Similar to the above aspect of the invention, this method may also include reading the information provided by the person from an information recordable medium.

Other objects and further features of the present invention will become readily apparent from the following description of certain embodiments with reference to accompanying drawings.

### BRIEF DESCRIPTION OF THE DRAWINGS

FIG. 1 is a block diagram of one embodiment of a management system.

FIG. 2 is a block diagram of one embodiment of a network installed in an apartment building.

FIG. 3 is a block diagram of one embodiment of the management device shown in FIG. 1.

FIG. 4 is one embodiment of an exemplary management table stored in the storage part of FIG. 3.

FIG. 5 is a block diagram of one embodiment of the interconnecting device shown in FIG. 1.

FIG. 6 is a block diagram of one embodiment of the network device shown in FIG. 1.

FIG. 7 is a block diagram of one embodiment of the guard manager shown in FIG. 1.

FIG. 8 is a flowchart illustrating one embodiment of a process of creating the management table.

FIG. 9 is a flowchart illustrating one embodiment of an initial setup operation of the management system shown in FIG. 1.

FIG. 10 is a flowchart illustrating one embodiment of a housing management operation by a guard manager when a resident is about to leave their apartment.

FIG. 11 is a flowchart illustrating one embodiment of a management device's management operation of the guard manager when the resident is about to leave their apartment.

FIG. 12 is a flowchart illustrating of one embodiment of a housing management operation by the guard manager while the resident is absent.

FIG. 13 is a flowchart illustrating one embodiment of a management device's management operation over the guard manager while the resident is absent.

FIG. 14 is a flowchart illustrating one embodiment of a housing management operation by the guard manager when the resident returns to their apartment.

FIG. 15 is a flowchart illustrating one embodiment of a management device's management operation of the guard manager when the resident returns to their apartment.

### DETAILED DESCRIPTION OF CERTAIN EMBODIMENTS

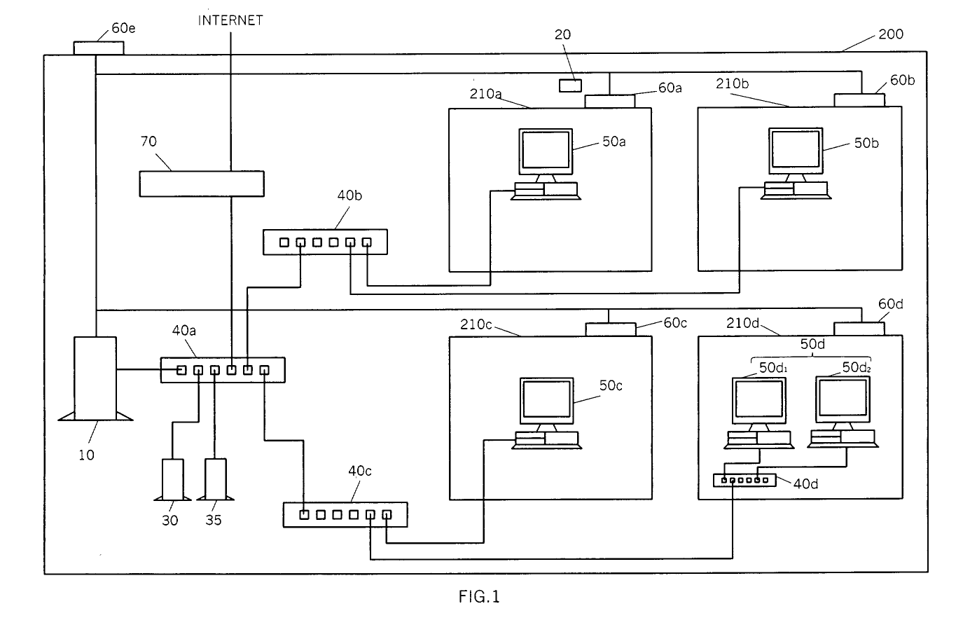

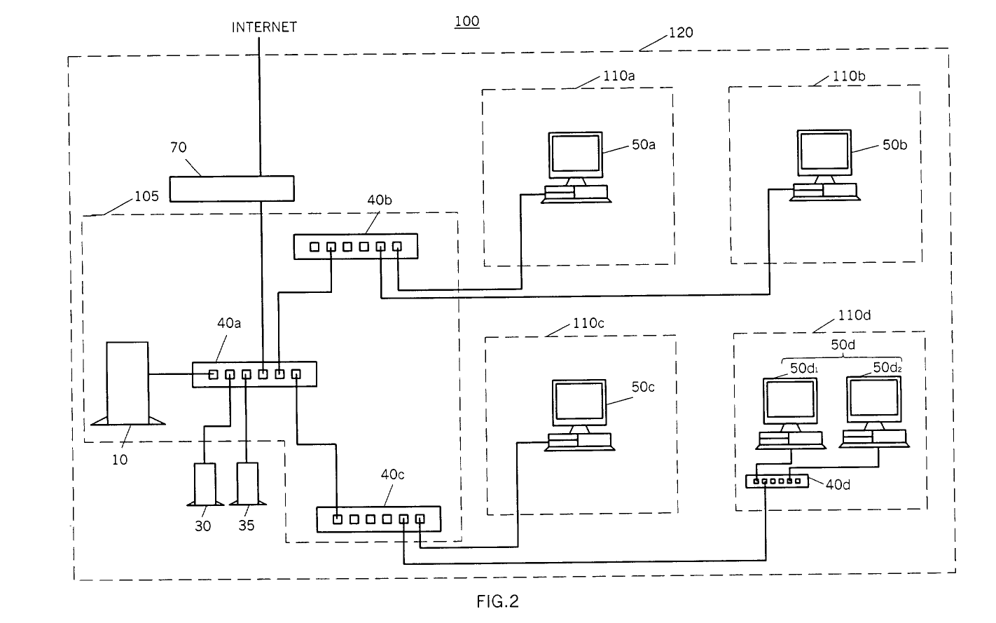

A description will now be given of one embodiment of a management system 1 with reference to the accompanied drawings. FIG. 1 is a structural diagram of the management system 1, and FIG. 2 is a structural diagram of one embodiment of a network 100 installed in an apartment building 200. In one embodiment, the management system 1 comprises a management device 10, an entrance server 30, a DHCP (Dynamic Host Configuration Protocol) server 35, a plurality of interconnecting devices 40, a plurality of network devices 50, a plurality of guard managers 60, and a router 70. As described herein, the interconnecting devices 40, network devices 50, guard managers 60, and apartments 210 respectively corresponds to interconnecting devices 40a-40d, network devices 50a-50d, guard managers 60a-60e, and apartments 210-210d, unless otherwise specified.

In one embodiment, the management system is applied to the environment of an apartment building 200, which includes a plurality of managed areas, i.e., apartments 210a-210d. The apartment building 200 has several interconnecting devices 40 building a network among the apartments 210. The apartments 210a-210d have network devices 50a-50d, configured for connection to the network 100. In the apartment 210, the network device 50 can access the network 100 by being connected to a network terminal, such as a LAN connector, which is connected to the interconnecting device 40, in the apartment 210. Each apartment 210 may be provided in advance with a network device 50 in accordance with a resident's request.

In one embodiment, the network 100 in the apartment building 200 can be adapted with the network devices 50a-50d in the following manner: the network device 50a and 50b are connected to the interconnecting device 40b, the network devices 50c and 50d are connected to the interconnecting device 40c, and the interconnecting devices 40b and 40c are connected to the interconnecting device 40a. As seen in apartment 210d, the network 100 may form a subnet using a hub 40d and the network devices 50d, i.e., network devices 50d1 and 50d2 (50d generalizes 50d1 and 50d2 unless otherwise specified). The management device 10, entrance server 30, DHCP server 35, and router 70 are connected to the interconnecting device 40a. The management device 10, entrance server 30, and DHCP server 35 can be provided in a separate management room for managing the apartment building 200, for use by the administrator of the apartment building 200.

The guard managers 60a-60d are respectively provided for the apartments 210a-210d, and configured to communicate with the management device 10. The guard manager 60 can be located, for example, outside the apartment 210 and near a door at the entrance of the apartment 210. As discussed later, this guard manager 60 can be used when the resident leaves or returns home. In one embodiment, another guard manager 60 (not shown in FIG. 1) can additionally be provided inside each apartment 210, so as to change the security level while the resident is inside the apartment, e.g., when the resident is sleeping.

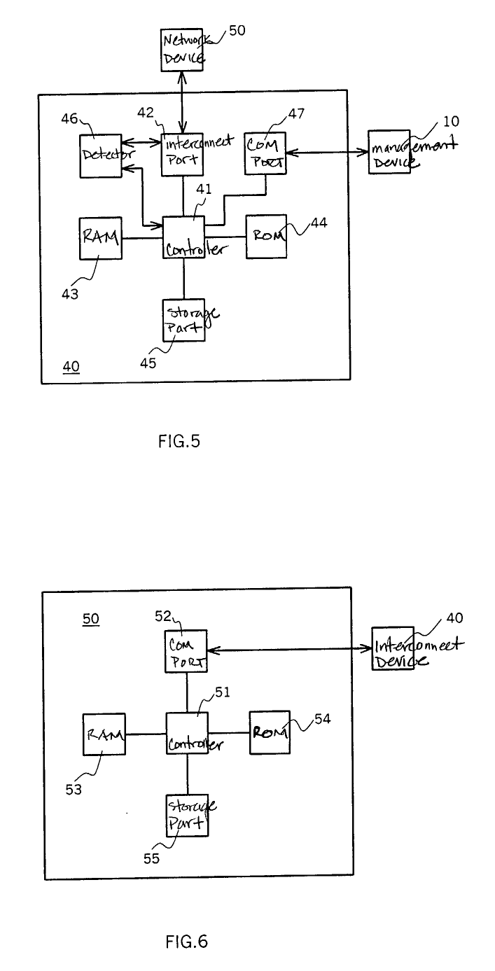

The present embodiment uses a cable for connection between the guard manager 60 and the management device 10, however, any type of data communication including radio and wire communications can also be used. Locks 212 and 214, shown in FIG. 6, can be provided at the door and/or window of the apartment 210. The locks 212 and 214 can be implemented as electronic locks whose lock and unlock functions are controlled by an electrical signal. The locks 212 and 214 are connected to the guard managers 60a-60d in the apartments 210a-210d.

It will be appreciated that the structures shown in FIGS. 1 and 2 are for illustrative purposes only, and the present invention is not limited to the number of apartments 210 shown, or the number of network devices 50 shown in each apartment 210.

The management device 10 manages the guard managers 60 as well as the network 100. More specifically, the management device 10 configures the interconnecting devices 40 such that a different VLAN is assigned to each apartment 210 based on network information of the network device 50, such as a device identifier and/or a communication parameter. Moreover, the management device 10 verifies or authenticates information sent from the guard manager 60, including the network information, and manages the guard managers 60 according to the information. Although the present embodiment uses a device identifier, a communication parameter may be used for authentication and/or verification purposes.

The management device 10 can also manage connection status and traffic of each network device 50 via the interconnecting device 40, although this management is not described in detail. For example, the network device 10 can obtain the communication amount and/or communication time for each communication port 42 of the interconnecting device 40 from the interconnecting device 40. Based on the obtained communication amount and/or communication time, the management device 10 may control communications of the communication port 42 and create billing information.

The management device 10 is illustrated in this embodiment as a desktop PC, which includes an external or internal integrated circuit (IC) card drive 18. A contact-type IC card 20 is used in the present embodiment for the IC card drive 18, however the noncontact-type IC card is not excluded from the present invention. Further, the present invention is also applicable to information recordable media other than an IC card.

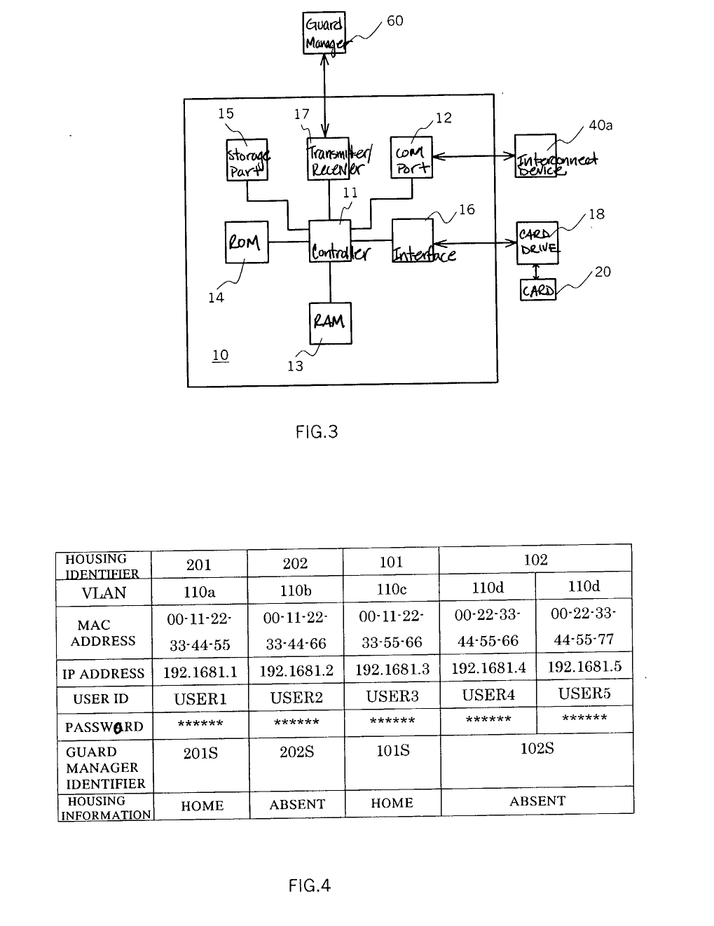

FIG. 3 is a block diagram of the management device 10. The management device 10 includes, as shown in FIG. 3, a controller 11, a communication port 12, a RAM (Random Access Memory) 13, a ROM (Read Only Memory) 14, a storage part 15, an interface 16, a transmitter/receiver 17, and the IC card drive 18. FIG. 3 does not show input/output devices (e.g., a keyboard, a mouse or other pointing devices, and an indication device, such as a display) provided with the management device 10. Through the input/output devices, an operator of the management device 10 may control the IC card drive 18, store various kinds of data in the storage part 15, and download software into the RAM 13, ROM 14 or storage part 15. In addition, the management device 10 can activate an alarm to alert the administrator via an output device, for example, when the guard manager 60 informs the management device 10 of any intrusion into the apartment 210.

The controller 11 can be a processor, such as a central processing unit (CPU) or a microprocessor (MPU),and controls each module in the management device 10. The management device 10 may be connected to a host (not shown), and the controller 11 may communicate with the host.

The controller 11 receives information from a network management table created by the entrance server 30, and creates a management table 15a. The controller 11 can store all or part of the management table 15a in the IC card 20 via the IC card drive 18. In operation, the controller 11 refers to the management table 15a, executes a management program stored in the storage part 15, and manages the guard managers 60.

As previously discussed, the controller 11 may activate an alarm to alert the administrator (and an outside security company or the police) when the guard manager 60 informs the management device 10 of an intrusion into the apartment 210, or when the controller 11 determines that the information sent from the guard manager 60 does not correspond to the stored network information, etc.

The controller 11 can configure the interconnecting device 40 via the communication port 12 so as to assign a different VLAN to each apartment 210 based on the network information of the network devices 50 in the management table 15a, as will be described later.

Referring back to FIG. 1, in one embodiment, the controller 11 assigns the same VLAN 105 as that of the management device 10 to the interconnecting devices 40. Therefore, the management device 10 may control the interconnecting devices 40 in the VLAN 105, and perform a VLAN configuration for the interconnecting devices 40. The controller 11 assigns VLANs 110a-110d, different from the VLAN 105, to the network devices 50a-50d in the apartments 210a-210d. Thereby, the management device 10 cannot access files in the network device 50 in each apartment 210. Conversely, the network devices 50 can neither access files in the network device 10 nor perform a VLAN configuration for the interconnecting devices 40. In addition, the network device 50 in one apartment 210 (e.g., the apartment 210a) cannot access files in the network device 50 of another apartment 210 (e.g., the apartment 210d). The controller 11 assigns a VLAN 120 to the entrance and DHCP servers 30 and 35. The VLAN 120 allows the entrance and DHCP servers 30 and 35 to communicate with the VLANs 105 and 110a-110d.

The communication port 12 may be an LAN adapter connected to the interconnecting devices 40, and a USB port or IEEE 1394 port for providing connection to the Internet (as necessary, via an Internet Service Provider (ISP)) via a modem, or a terminal adapter (TA) through the public telephone network, ISDN, or various types of dedicated lines. The RAM 13 can temporarily store data to be read from the ROM 14 and storage part 15, data to be written in the storage part 15, and the like. The ROM 14 can store various kinds of software and firmware for operation of the controller 11, and other types of software.

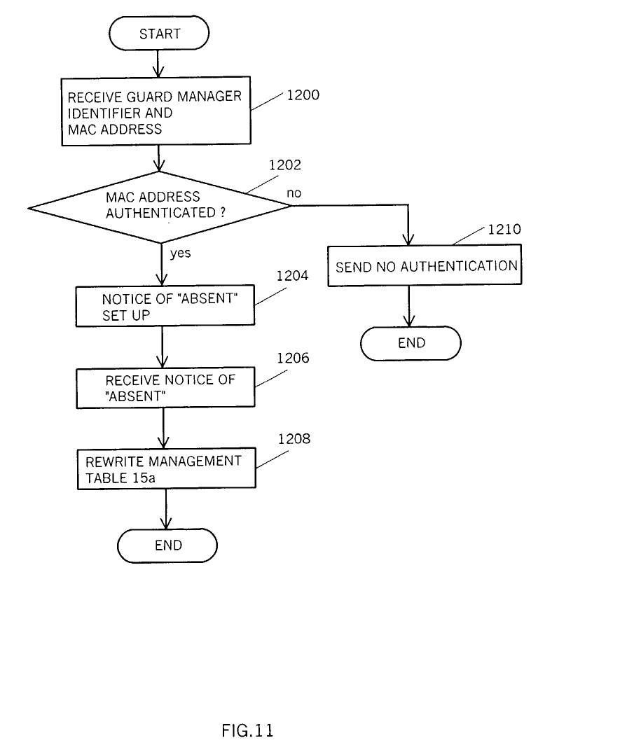

FIG. 4 shows an exemplary management table 15a. The storage part 15 stores a management program for managing the guard managers 60, which will be described later with reference to FIGS. 11, 13, and 15, as well as the management table 15a shown in FIG. 4. The management program may be distributed as an independent commodity, stored in a CD-ROM or other recordable media to be sold, or distributed and updated online via a network, such as the Internet.

The management table 15a in this embodiment includes information for guard management. Such information can include, as shown in FIG. 4, network information of the network device 50 including a housing identifier, VLAN information, MAC (Media Access Control) address, IP (Internet Protocol) address, user ID, and password. The management table 15a can also store an identifier of a guard manager 60 corresponding to the apartment 210 and a status of the apartment 210.

Optionally, the management table 15a may further include a status of the guard manager 60. Consequently, the guard manager 60 may change its status or operational mode corresponding to a security level even when the status of the apartment 210 does not change. For instance, the resident of the apartment 210 sometimes may want to enhance the security level of the apartment while sleeping. In this case, two or more security levels may be used. A high security level can be used while the resident is away from the apartment 210, and a high or intermediate security level can be used while the resident is sleeping, etc. A low security level can be used while the resident is at the apartment 210 during waking hours. It is understood that a change of a security level can sometimes be effective for example, because a resident seldom opens a window while sleeping, although he/she frequently opens the window in the daytime.

Housing identifiers 101, 102, 201 and 202, respectively identify four apartments 210a-210d. In this embodiment, the housing identifiers are apartment numbers in the apartment building 200, but any number and/or symbol may be used, such as consecutive or non-consecutive arbitrary numerals for identifying the apartment 210 in the apartment building 200.

The VLAN information can be the same as that assigned by the management device 10. The MAC address can be used to identify an information device connected to a LAN.

The IP address is a period separated four-block address, each block ranging 0-255 in decimal notation, assigned to a computer connected to a TCP/IP (Transmission Control Protocol/Internet Protocol) network configuration. The IP address is included in an IP header provided by the IP protocol in the network layer in the TCP/IP protocol. The IP address of a computer directly connected to the Internet can be obtained from the NIC (Network Information Center). Alternatively, the IP address can be replaced with a DNS (Domain Name System) address.

The user ID and password are identifiers for identifying network device 50's user who attempts to login to the network 100.

The guard manager identifier is an identifier of the guard manager 60 provided in the apartment 210. The housing information can indicate the status of the apartment 210 by identifiers such as “home” or “absent”.

The administrator or controller 11 stores the housing identifier, VLAN, and guard manager identifier, while the controller 11 stores the MAC address, IP address, user ID, and password by receiving them from the entrance server 30, as will be described later. The administrator can record the housing information as “absent” (prior to resident's inhabiting the apartment 210), and the controller 11 can change the housing information between “home” and “absent”, as will be described in more detail later.

The interface 16 can be, for example, a USB port or a parallel port, and connects the management device 10 to an external device, e.g., the IC card drive 18 in this embodiment. The interface 16 can be an interface irrespective of a type of data transmission method, such as parallel and serial systems, and a connection medium, such as a radio and wire transmissions.

The transmitter/receiver 17 connects the management device 10 to the guard managers 60 to establish communication between the two devices. Although this embodiment indicates the interface 16 and the transmitter/receiver 17 as independent members, the interface 16 may serve as part of the transmitter/receiver 17. The transmitter/receiver 17 can be an interface irrespective of a type of data transmission method, such as parallel and serial systems, and connection medium, such as a radio and wire transmissions.

The IC card drive 18 writes data into and reads data from the IC card 20. The IC card drive 18 can record part of the management table 15a, including the MAC address, which is output by the controller 11 via the interface 16, onto the IC card 20 in this embodiment. As described above, the present invention is not limited to use of an IC card. Therefore, an appropriate drive may be used depending upon a type of an information recordable medium. The IC card drive 18 may use any technology known in the art or be manufactured by those skilled in the art, and a detailed description is therefore omitted.

In one embodiment, the IC card 20 serves as an access key to enter the apartment 210. The IC card 20 can be a smart card, an intelligent card, a chip-in card, a microcircuit (or microcomputer) card, a memory card, a super card, a multifunctional card, a combination card, etc. Also, the IC card is not limited to a card-shaped medium, but may include any shape, such as a stamp size and smaller ultra-micro and coin shapes.

In one embodiment, the entrance server 30 permits a login to the network by the network device 50 having a predefined MAC address. The entrance server 30 includes a controller, a communication port, a RAM, a ROM, and a storage part, which are not illustrated. The entrance server can be especially effective when the present invention is applied to an office building. Suppose that an intruder, e.g., a corporate spy brings his notebook PC and intrudes into an office room. The entrance server does not permit his PC to access the network due to the wrong MAC address on the intruder's PC.

The controller can execute a program, such as the program illustrated in FIG. 8, to build a network management table. Referring to the management table, the controller permits the network device 50 having a predefined MAC address to login to the network 100.

The communication port may be an LAN adapter connected to the interconnecting devices 40, and a USB port or IEEE 1394 port for providing connections to the Internet (as necessary, via an Internet Service Provider (ISP)) via a modem, or a terminal adapter (TA) through the public telephone network, ISDN, or various types of dedicated lines.

The RAM temporarily stores data to be read from the ROM and storage part, data to be written in the storage part, and the like. The ROM can store various kinds of software and firmware for operations of the controller, and other types of software.

The storage part stores a management-table creating program for creating the network management table, and the resultant network management table. In one embodiment, the network management table stores, where five network devices 50 are connected to the network and its subnet(s), a relationship between the apartments 210 and communication parameters and device information of the corresponding network 50.

In one embodiment, the communication parameters include an IP address assigned by the DHCP server 35, and a user ID and password, but may further include a subnet mask and a default gateway. The entrance server 30 obtains and stores these pieces of information from users of the network devices 50 offline, i.e., via telephone, facsimile, or mail, before creating the network management table.

The subnet mask is a bit pattern for separating the host address part in the IP address into subnet and host addresses. When “255.255.255.0” is defined by the subnet mask, the first three numbers are represented in binary notation as “11111111”. A “1” denotes the same network in the subnet mask.

The default gateway is an IP gateway through which a host transmits an IP datagram, except when the host for transmitting the IP datagram incorporates a routing table including a destination IP address, and when the destination IP address has the same network address as the transmitting host.

The communication parameters are not limited to the above, but may include a DNS address and a router address.

The typical device information of the network device 50 is a MAC address, but may include a housing identifier, and hardware and firmware versions. The housing identifier is an identifier for a housing of the network device 50. The hardware and firmware versions are, respectively, hardware and firmware versions of the network device 50.

The DHCP server 35 assigns communication parameters, e.g., the IP address, subnet mask, default gateway, to a plurality of network devices 50. The DHCP server 35 may use any technology known in the art, and a detailed description is therefore omitted.

The interconnecting device 40 connects the network device 50 to the network 100, and includes one or more interconnecting ports for connection to the network device 50. The interconnecting device 40 can be, for example, a hub, a switch, a router, any other concentrator, a repeater, a bridge, a gateway device, a PC, or a wireless interconnecting device (e.g., an access point as an interconnecting device for wireless LAN).

FIG. 5 is a block diagram of the interconnecting device 40. The interconnecting device 40 includes a controller 41, an interconnecting port 42, a RAM 43, a ROM 44, a storage part 45, a detector 46, and a communication port 47. FIG. 5 also omits the input/output devices, which may be provided with the interconnecting device 40, for simplicity purposes. Through the input device, an operator of the interconnecting device 40 may input various kinds of data in the storage part 45, and download software into the RAM 43, ROM 44, and storage part 45.

The controller 41 can be a processor such as a CPU or an MPU, and controls each module in the interconnecting device 40. The controller 41, in conjunction with the present invention, communicates with the detector 46, provides information for identifying the network device 50 to the entrance server 30, and manages interconnecting ports 42 to assign a different VLAN to each apartment 210 based on the MAC address of the network device 50 to be connected to the interconnecting device 40.

The controller 41 may execute a predefined operation in accordance with information sent by the guard manager 60 to the management device 10. The predefined operation may include, for example, collection of predefined information from the Internet and restriction of access to the network. This trigger function of the interconnecting device 40 can be advantageous to achieve an automatic process. For example, a parent who is going out, may request the management device 10, via the guard manager, to control the controller 41 so as to restrict his/her child's Internet access to educational homepages.

The interconnecting port 42 is a communication port configured for connection to each network device 50 by a cable or the like. more specifically, the interconnecting devices 40b and 40c are connected to the interconnecting ports 42 in the network device 40a. The network devices 50a and 50b are connected to the interconnecting ports 42 in the interconnecting device 40b, while the network devices 50c and 50d (i.e., 50d1 and 50d2 via the interconnecting ports in the hub 40d) are connected to the interconnecting ports 42 in the interconnecting device 40c.

The RAM 43 temporarily stores data to be read from the ROM 44 and storage part 45, data to be written in the storage part 45, and the like. The ROM 44 can store various kinds of software and firmware for operation of the controller 41, and other types of software. The storage part 45 can store a program for managing the interconnecting ports 42.

The detector 46 detects power-on of the network device 50 by communicating with the interconnecting port 42, and notifies the controller 41 of the detection result. Since the detector 46 can use any structure and method known in the art, for example, comparing the voltage of the interconnecting port 42 with a specific slice level for detection purposes, a detailed description of the detector 46 is omitted.

The communication port 47 may be an LAN adapter, a USB port or IEEE 1394 port for providing connections to the Internet (as necessary, via an Internet Service Provider (ISP)) via a modem, or a terminal adapter (TA) through the public telephone network, ISDN, or various types of dedicated lines. The interconnecting device 40 can communicate with the management device 10 via the communication port 47.

The network device 50 is a device managed by the management device 10, and includes a network device, such as a hub, a switch, a router, any other concentrator, a repeater, a bridge, a gateway device, a PC, a server, a wireless interconnecting device (e.g., an access point as a interconnecting device for wireless LAN), or a game machine having a communication function.

FIG. 6 is a block diagram of the network device 50. The network device 50 includes a controller 51, a communication port 52, a RAM 53, a ROM 54, a storage part 55, an interface 56, a power-supply controller 57, and an IC card drive 60. FIG. 6 also omits the input/output devices, which can be provided with the network device 50, for simplicity purposes. Through the input device, an operator of the network device 50 may input various kinds of data in the storage part 55, and download software into the RAM 53, and ROM 54 and storage part 55.

The controller 51 can be a processor such as a CPU or an MPU, and controls each module in the network device 50. The communication port 52 may be an LAN adapter for establishing a connection to the network, a USB port or IEEE 1394 port for providing connection to the Internet (as necessary, via an Internet Service Provider (ISP)) via a modem, or a terminal adapter (TA) through the public telephone network, ISDN, or various types of dedicated lines.

In one embodiment, the communication port 52 is an interface to be connected to the interconnecting port 42 in the interconnecting device 40. The RAM 53 temporarily stores data to be read from the ROM 54 and storage part 55, data to be written in the storage part 55, and the like. The ROM 54 stores various kinds of software and firmware for operation of the controller 51, and other types of software. The storage part 55 stores a communication parameter and a configuration program. The configuration program receives communication parameters from the DHCP server 35 and configures them.

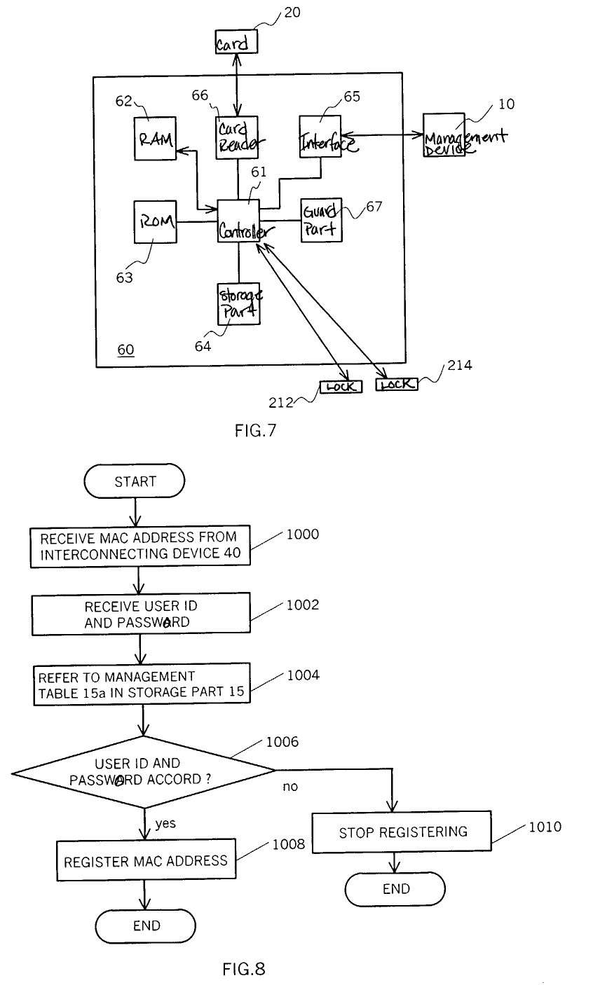

FIG. 7 is a block diagram of the guard manager 60. Each guard manager 60 is configured to guard the apartment building 200 or the corresponding apartment 210. The guard manager 60 includes a controller 61, a RAM 62, a ROM 63, a storage part 64, an interface 65, an IC card reader 66, and a guard part 67. The guard manager 60 may include input/output devices (e.g., a keyboard, a ten key, and a display) (not shown). Through the input device, an operator (or resident) of the guard manager 60 may input data for the guard manager 60 or management device 10. For example, when a resident leaves their child in the apartment 210, the resident can use the IC card 20 to enter information indicating that they are going out. The resident can use the input device (not shown) to enter information indicating that someone is still in the apartment 210 so that the child may not be regarded as an intruder. The output device of the guard manager 60 may include a warning device, such as a speaker to issue a warning to an intruder, and a warning light.

The controller 61 can be a processor such as a CPU or an MPU, and controls each module in the guard manager 60. In one embodiment, the controller 61 executes the management program stored in the storage part 64, and guards the apartment 210, together with the management device 10, against intrusion. The controller 61 reads a device identifier, or information including a device identifier, stored in the IC card 20 using the IC card reader 66, and controls locking and unlocking of locks 212 and 214 located at the apartment's entrance points, such as a door and/or window of apartment 210.

The RAM 62 temporarily stores data to be read from the ROM 63 and storage part 64, data to be written in the storage part 64, and the like. The ROM 63 can serve to store various kinds of software and firmware for operations of the controller 61, and other types of software.

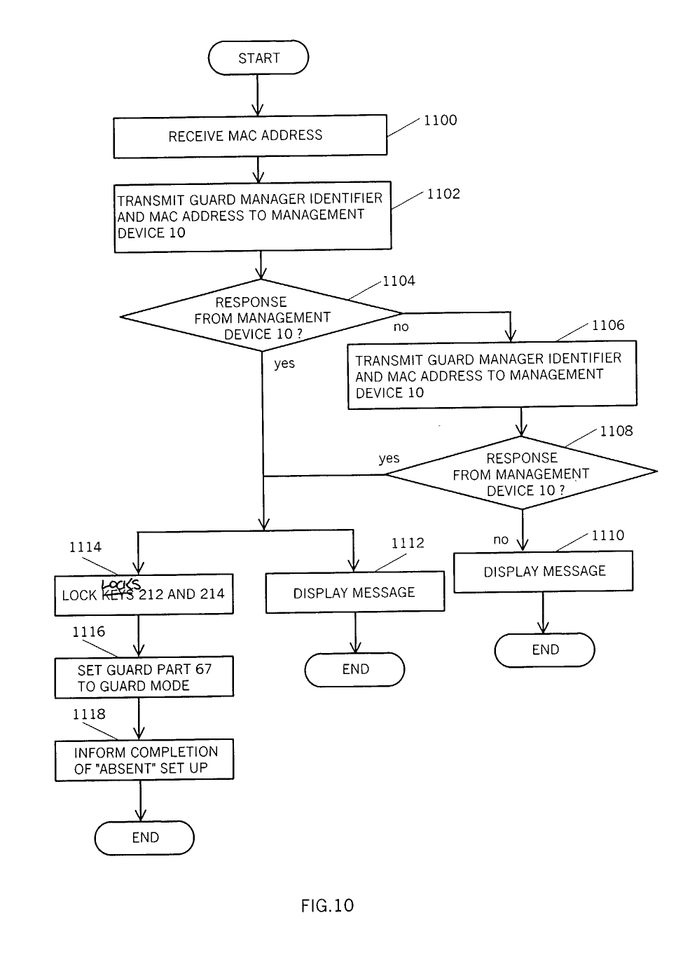

The storage part 64 stores the guard manager identifiers and the management program for the apartments 210. The management program is a program that controls admittance into the apartment 210, which will be described later with reference to FIGS. 10, 12 and 14. The management program may be distributed as an independent commodity, thus stored in a CD-ROM or other recordable medium, sold, and distributed and updated online via a network, such as the Internet.

The interface 65 can be, for example, a USB port or a parallel port, and connects the guard manager 60 to the management device 10. The interface 65 can be an interface irrespective of a type of data transmission method, such as parallel and serial systems, and a connection medium, such as a radio and wire transmission.

The IC card reader 66 reads information stored on the IC card 66. Although the IC card reader 66 can only read the information from the IC card 20 in this embodiment, it may be implemented as a reader/writer that may serve as a recorder. Such a reader/writer, when replaced with the IC card reader 66, may write IC card 20's use history (such as date/time and the number of reads) onto the IC card 20. The IC card reader 66 may use any technology known in the art, and a description thereof is omitted.

The guard part 67 monitors intrusion into the apartment building 200 or apartment 210. For example, the guard part 67 guards against an intruder who attempts to enter the apartment 210, while the resident is absent, by breaking the window or door, or by unlocking the locks 212 or 214. The guard part 67, in this embodiment, may use an infrared sensor, a vibration sensor, a sound sensor, or a guard sensor combining two or more of these sensors, and can be provided at the window, the door, and the like. In one embodiment, the guard part 67 includes a digital or video camera for photographing an intruder. The still or motion picture data can be sent to the management device 10 for security purposes. The guard part 67 can have guard and non-guard modes, switched by the controller 61 or the resident of the apartment 210. In one embodiment, there are several guard modes having different security levels.

In one embodiment, the guard mode is set when the infrared, vibration, and/or sound sensors turn on. For example, the infrared sensor is comprised of a pair of infrared light emitting and receiving elements, and provided on a door, a window, and the like, along an intrusion path upon the apartment 210. The infrared sensor detects an interruption of the infrared light from the infrared light emitting element toward the infrared light receiving element. The vibration sensor, provided on a floor in the apartment 210, detects vibrations of the floor. The sound sensor, provided in the inside of the apartment 210, detects sounds larger than normal living sounds, such as a crash of window glass. The guard part 67 is connected to the controller 61, and thus the controller 61 may monitor the status of the sensor. The non-guard mode can be set when the infrared, vibration, and/or sound sensors turn off.

The guard part 67 may further include a gas leakage detector, a temperature sensor, etc. to detect a potential hazard, such as the escape of gas and presence of fire.

A description will now be given of one embodiment of an operation of the management system 1. Upon initial start up, the management device 10 does not know the device information of the network device 50, and the administrator needs to obtain the device information to create the management table 15a. This action preferably follows, for example, a new resident occupying the apartment building 200.

It may not be necessary to perform an initialization operation, such as the one which will be described later with reference to FIG. 8, for residents who have no network device 50. However, as described below, it may be necessary to store network information in the IC card 20 to activate the guard manager 60 for these residents. Accordingly, the administrator can provide such residents with unique device information without compromising network security, and the residents cannot login to the network 100 until they acquire a network device 50.

FIG. 8 is a flowchart illustrating a method of creating the network management table. Referring to FIG. 8, the entrance server 30 creates the network management table for managing the network devices 50, which constitute the network 100.

In a state 1000, the resident connects the network device 50 to the network 100, and a controller of the network server 30 receives a MAC address of the network device 50 from the interconnecting device 40, which the network device 50 is connected to. In a state 1002, the controller 11 receives a user ID and password from the network device 50, wherein the user ID and password are entered by the resident at the network device 50, to login to the entrance server 30. In a state 1004, the controller refers to the network management table in the storage part, and in a state 1006 the controller determines whether the received user ID and password correspond with those in the network management table. If no authentication is reached in state 1006, then the controller stops the registration of the MAC address in a state 1010. If an authentication has been reached in state 1006, the controller allows a registration of the MAC address in the network management table in a state 1008. Simultaneously the entrance server 30 may allow the DHCP server 35 to configure the communication parameters for the network device 50, including the IP address.

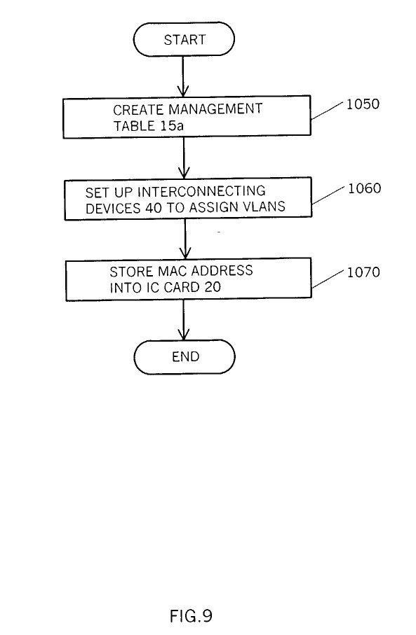

FIG. 9 is a flowchart illustrating an initial setup operation of the management system 1. In a state 1050, the management device 10 creates the management table 15a as shown in FIG. 9. The controller 11 requests the entrance server 30 to provide information for the network management table. In response, the entrance server 30 sends the desired information to the management device 10. In one embodiment, the desired information includes the MAC address, IP address, user ID and password.

In a state 1060, the controller 11 configures the interconnecting device 40 so as to assign a different VLAN to each apartment 210 based on the MAC address stored in the management table 15a. In a state 1070, the management device 10 stores the MAC address (or the MAC address and other information) in the IC card 20 using the IC card drive 18.. The initial setup operations may include creation of the network management table by the entrance server 30.

A description will now be given of the management method of the network 100 in the management system 1. Entrance server 30's controller receives a notice from the interconnecting device 40, via the communication port, of the network device 50 powering-on, wherein the network device 50 is connected to the interconnecting device 40. The entrance server 30's controller then receives the MAC address of the network device 50 from the interconnecting device 40. The entrance server 30's controller refers to the network management table in the storage part, and determines whether the received MAC address has already been stored.

When the received MAC address has already been stored in the network management table, the entrance server 30's controller allows the DHCP server 35 to assign the communication parameters, including the IP address, to the network device 50 with the received MAC address. Then, the entrance server 30's controller records the communication parameters in the network management table, and allows the interconnecting device 40 to communicate, using its interconnecting port 42 connected to the network device 50, using the received MAC address. Thereby, the network device 50 may access the Internet via the router 70, and other network devices in the same VLAN. As described above, the management device 10 can manage structure, performance, security, and billing of the network 100 by managing the connection and traffic statuses of the network device S0 via the interconnecting device 40.

When the received MAC address has not yet been stored in the network management table, the entrance server 30's controller prohibits the DHCP server 35 from assigning the communication parameters, including the IP address, to the network device 50 with the received MAC address. The entrance server 30's controller also prohibits the interconnecting device 40 from communicating using its interconnecting port 42 connected to the network device 50 with the received MAC address. The entrance server 30's controller may notify the management device 10 of the unauthorized attempted access to the network 100, and in response, the controller 11 may activate an alarm to notify the administrator.

The entrance server 30, using such an operation, can permit the network device 50 with the predefined MAC address to access the network 100, and prohibit an unauthorized network device to access the network 100. The user ID and password are used in the initial setup, and need not, but may, be entered whenever the user attempts to access the network 100. Although the conventional authentication system utilizing a user ID and password may unintentionally give an intruder an opportunity to steal the user ID and password, the present management system easily eliminates such an intruder because he/she cannot easily obtain the MAC address of the network device 50 nor the knowledge that the MAC address is used for authentication.

The administrator may store the communication parameter, including the IP address, recorded in the management table 15a, in the IC card 20 when the resident uses the network device 50 that has succeeded in a communication at least once.

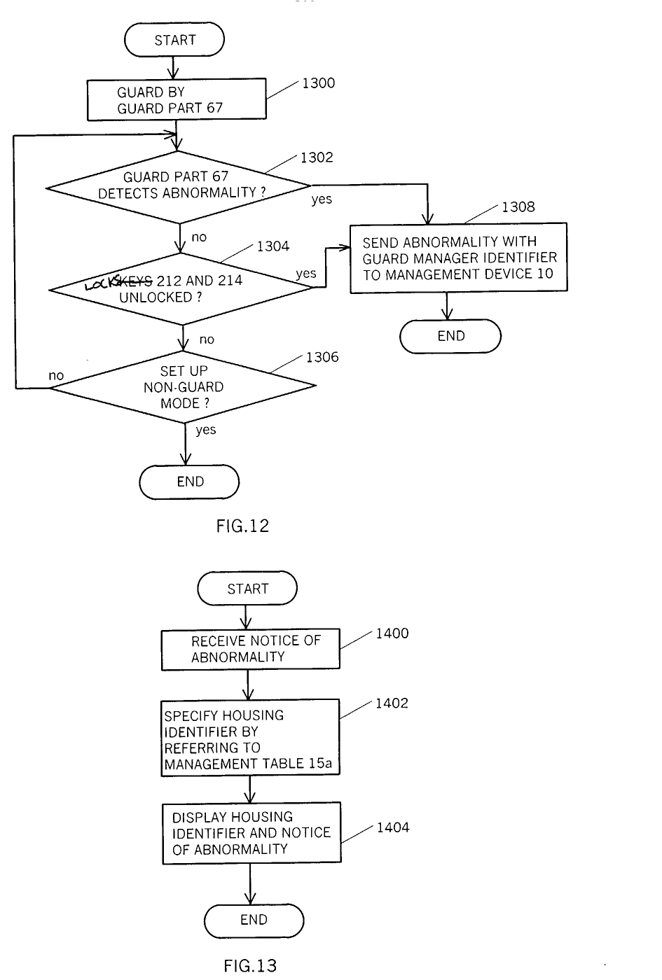

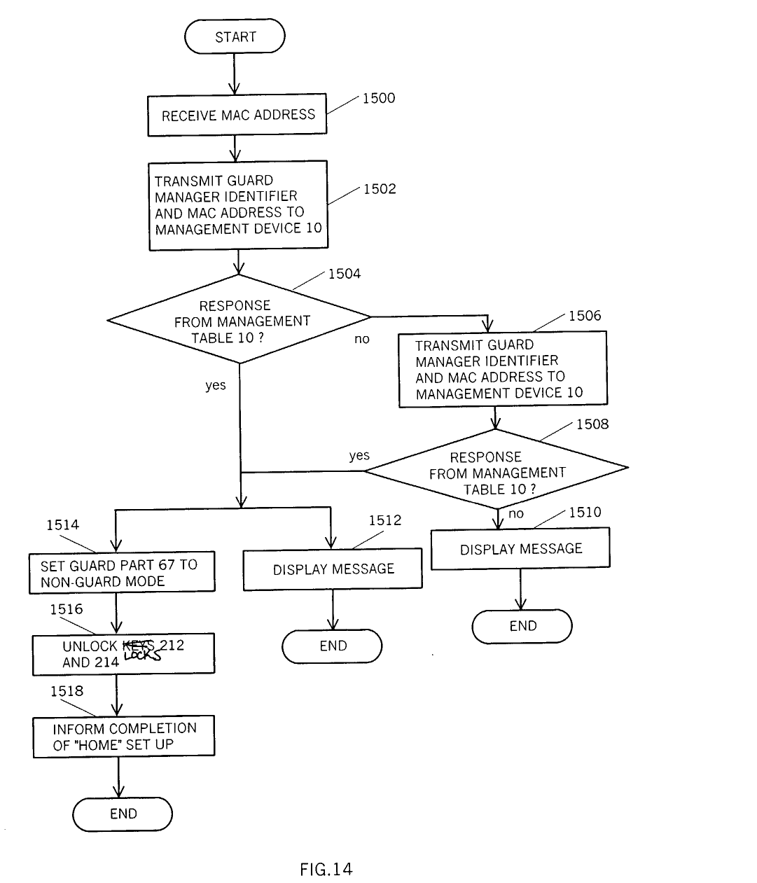

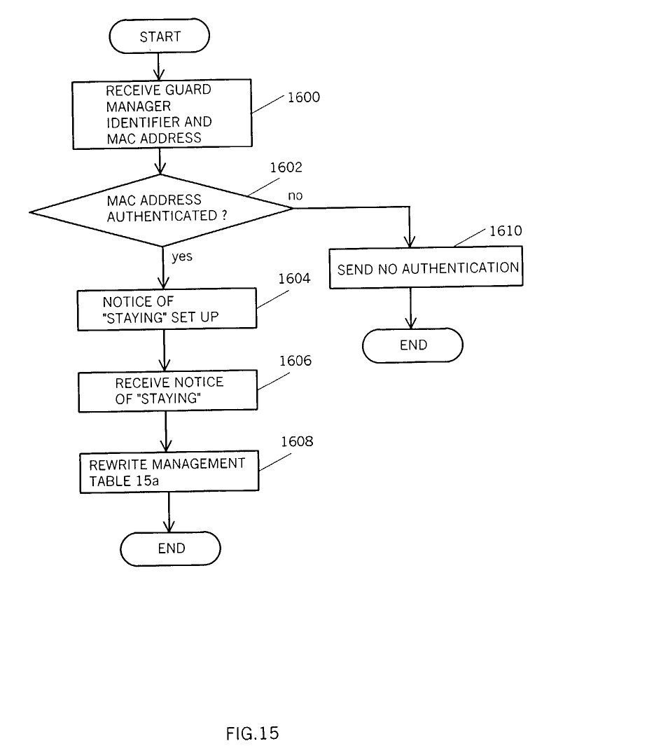

A description will now be given of the management method of the apartment 210 in the management system 1, with reference to FIGS. 10-15. FIG. 10 is a flowchart illustrating how the guard manager 60 guards the apartment 210 when a resident is about to leave, and FIG. 11 is a flowchart illustrating how the management device 10 manages the guard manager 60 when the resident is about to leave. FIG. 12 is a flowchart illustrating how the guard manager 60 guards the apartment 210 while the resident is absent, and FIG. 13 is a flowchart illustrating how the management device 10 manages the guard manager 60 while the resident is absent. FIG. 14 is a flowchart illustrating how the guard manager 60 manages the apartment 210 when a resident returns home, and FIG. 15 is a flowchart illustrating how the management device manages the guard manager 60 when a resident returns home. Although the following description describes the management method using the MAC address among information stored in the IC card 20, other network information, such as the IP address, housing identifier, another communication parameter, VLAN, and an arbitrary combination thereof can be used instead of or in addition to the MAC address.

Initially, a resident of the apartment 210 receives the IC card 20 from the administrator. The IC card 20 stores the MAC address of the network device 50 located in the corresponding apartment 210 as a result of the initial setup operation. Where the apartment 210 is furnished with the network device 50, the resident may receive the IC card 20 from the administrator on or before moving in to the apartment 210. Where the apartment 210 is not furnished with the network device 50, the resident can connect a network device shortly after moving in to the apartment 210. With this connection, the administrator executes the above initial setup operation, and the resident receives the IC card 20.

For the resident who has moved in but will not be connecting a network device 50 soon, the administrator can create an arbitrary MAC address and store it in the management table 15a and IC card 20, so as to activate the guard manager 60. Since the resident does not attempt to access the network 100, even the arbitrary MAC address does not lower the security in the network 100. In this embodiment, the resident uses the IC card 20 as a unique key to lock and unlock the locks 212 and 214. In an alternative embodiment, the resident uses the IC card 20 to change the security level or the operational mode of the guard manager 60, or to make the interconnecting device 40 execute a predefined program.

When the resident leaves the apartment 210, he/she inserts the IC card 20 into the IC card reader 66 in the guard manager 60. In a state 1100, the controller 61 of the guard manager 60 receives the MAC address, which is stored in the IC card 20, read by the IC card reader 66. In a state 1102, the controller 61 sends the MAC address with its identifier to the management device 10 via the interface 65. In a state 1104, the controller 61 determines whether there is an answer from the management device 10. The state 1104 may set a predefined time after the transmission in state 1102, in which to determine the presence of the response.

If the management device 10 does not respond in state 1104, e.g., within a predefined time period, the controller 61 transmits the guard manager identifier and the MAC address again in a state 1106. In a state 1108, the controller determines whether there is a response from the management device 10, similar to the state 1104. If no response is received in state 1108, the controller 61 indicates a message, such as “no answer, contact administrator,” on the display (not shown) of the guard manager 60 in a state 1110. Such a message can help confirm whether there is a communication with the management device 10. As described later, it can be advantageous for the guard manager 60 to communicate with the management device 10, and a confirmation of the connection status may contribute to determining any communication difficulties, including a cable disconnection. In addition, a plurality of states for confirming the communication with the management device 10 may distinguish the temporary and complete interruptions of communications with each other. A typical temporary communicative interruption is, for example, a temporary interruption of radio waves where the guard manager 60 is connected with the management device 10 using radio communication.

Referring now to FIG. 11, in a state 1200, the transmitter/receiver 17 in the management device 10 receives the guard manager identifier and the MAC address sent in state 1102, and transfers them to the controller 11. In a state 1202, the controller 11 refers to the management table 15a, specifies the housing identifier based on the guard manager identifier, and determines if it can authenticate the MAC address corresponding to the housing identifier.

When the controller 11 determines that it cannot provide an authentication in state 1202 (for example, because the resident inserts a broken, different apartment's or different purpose-made IC card into the IC card reader 66), the controller 11 informs the guard manager 60, via the transmitter/receiver 17, in a state 1210 that the information was not authenticated.

When the controller determines that it can authenticate the information in state 1201, the controller 11 obtains the housing information of the apartment 210 corresponding to the MAC address, and confirms the current status of the apartment 210. In a state 1204, the controller 11 informs the guard manager 60 via the transmitter/receiver 17 that it has changed the housing status to “absent” from the current status (i.e., “home”) of the apartment 210. Optionally, the controller 11 disconnects the network device 50 from the network through the corresponding interconnecting device 40, so as to enhance the network security.

In one embodiment, the resident leaves a child in the apartment 210, and, as described above, the resident may set different security levels for the same status of the apartment 210. Then, the resident may input additional information, for example, using the input device (not shown) in the guard manager 60. Of course, the resident may also use input means of the IC card reader 66.

Referring back to FIG. 10, in response to “yes” in state 1104 or 1108, the controller 61 executes a predefined procedure based on the received information via the interface 65. More specifically, when the controller 61 receives a notice that the MAC address was not authenticated, in a state 1112 it indicates a message “no authentication” on a display (not shown). Such a message may require the resident to use a proper IC card and repeat the above procedure. When the resident has used the proper IC card but receives such a message, he/she can contact the administrator.

When receiving a notice that the MAC address has been authenticated and “absent” was the set up chosen, the controller 61 locks the locks 212 and 214 in a state 1114, and sets the guard part 67 into the guard mode in a state 1116. In a state 1118, the controller 61 notifies the management device 10 that the “absent” set up has been completed for the apartment 210. After the state 1118, the controller 61 may indicate a message “lock and guard mode completed” on the display (not shown).

Referring to FIG. 11, in a state 1206, the controller 11 in the management device 10 receives the message of completion of the “absent” setup via the transmitter/receiver 17, and rewrites the housing information to “absent” in the management table 15a.

Thereby, the locking of the apartment 210 is completed and the guard part 67 guards the apartment 210 against intrusion, enhancing crime prevention effects in the management system 1.

Although the resident in the above states locks the apartment 210 by having the IC card reader 66 read the IC card 20, it will be appreciated that an alternative lock action may be employed.

A description will be given of the system operation while the resident of the apartment 210 is absent, with reference to FIGS. 12 and 13. While the resident is absent, the controller 61 in the guard manager 60 controls the guard part 67. To be more specific, in a state 1300, the controller 61 monitors whether the guard part 67, as implemented by the infrared, vibration, and/or sound sensors or a guard sensor combining them, detects abnormality as a possible intrusion. For example, when an intruder breaks the window glass of the apartment 210, the infrared sensor can detect an interruption of the infrared light along the intrusion path. The vibration sensor can detect vibrations of the floor along with intruder's intrusion. The sound sensor can detect a crash of the window. When each of these sensors detects interruption, vibration and sound exceeding a predefined level, it can send a predefined alarm signal to the controller 61. In one embodiment, the guard part 67 can photograph the intruder using a digital camera, video, etc., and send still or motion picture data to the controller 61.

The controller 61 monitors the locks 212 and 214. To be more specific, the controller 61 detects abnormality if the locks 212 and 214 are unlocked during the guard mode.

The controller 61, in response to receiving the signal in a state 1302 or detecting that the lock 212 or 214 is unlocked in a state 1304, informs the management device 10 of its guard manager identifier and abnormality in a state 1308. The controller 61 may inform the display (not shown) of the abnormality. The guard manager 60 may activate an alarm or buzzer to notify the intruder of the alarm.

The controller 11 in the management device 10, in response to receiving the notice of abnormality from the guard manager 60 via the transmitter/receiver 17 in a state 1400, refers to the management table 15a to identify the housing identifier based on the guard manager identifier in a state 1402, and indicates, on the display (not shown), the message of abnormality together with the number of the apartment 210 based on the housing identifier in a state 1404. The administrator, who has confirmed the message, can go to the apartment 210, or call the police or security company or take any other appropriate action.

The controller 11 may activate the alarm if the management device 10 has the alarm or buzzer so that the administrator may easily recognize the abnormality. The controller 11 may directly contact a security company via the Internet.

The controller 61 repeats the above procedures until the non-guard mode is set when the resident returns home, which will be described below.

A description will now be given of an operation when the resident returns home, with reference to FIGS. 14 and 15. The resident inserts the IC card 20 into the IC card reader 66 of the guard manager 60. Referring to FIG. 14, in a state 1500, the controller 61 of the guard manager 60 receives the MAC address from the IC card 20. In a state 1502, the controller 61 sends the identifier of the guard manager 60 and the MAC address to the management device 10 via the interface 65. In a state 1504, the controller 61 determines whether there is a response from the management device 10.

If the management device 10 does not respond in state 1504, e.g., within a predefined time period, the controller 61 transmits the guard manager identifier and the MAC address again in a state 1506, and, in a state 1508, the controller determines whether there is a response from the management device 10, similar to the state 1504. If no response is identified in state 1508, in a state 1510 the controller 61 indicates a message such as “no answer, contact the administrator” on the display (not shown) of the guard manager 60. Such a message can contribute to determining whether there is a confirmation of a communication with the management device 10 (for the same reason as states 1104-1110).

Referring to FIG. 15, the transmitter/receiver 17 in the management device 10 receives the guard manager identifier and the MAC address sent in state 1502, and transfers them to the controller 11 (state 1600). The controller 11 refers to the management table 15a, specifies the housing identifier based on the guard manager identifier, and authenticates the MAC address corresponding to the housing identifier (state 1602).

When the controller 11 determines that it cannot provide an authentication in state 1602 (for example, because the resident inserts a broken, different apartment's or different purpose-made IC card into the IC card reader 66), the controller 11 informs the guard manager 60, in a state 1610, via the transmitter/receiver 17, that the information was not authenticated.

When the controller determines that it can authenticate the information in state 1602, the controller 11 obtains the housing information of the apartment 210 corresponding to the MAC address, and confirms the current status of the apartment 210. The controller 11 informs the guard manager 60 via the transmitter/receiver 17 that the user has changed the housing status to “home” from the current status (i.e., “absent”) of the apartment 210 in a state 1604.

Referring back to FIG. 14, in response to a “yes” in state 1504 or 1508, the controller 61 can execute a predefined procedure based on the received information via the interface 65. More specifically, in a state 1512, when the controller 61 receives a notice that the MAC address was not authenticated, it indicates a message “no authentication” on the display (not shown). Such a message may require the resident to use the proper IC card and the above procedure repeats. When the resident has used the proper IC card but received such a message, he/she may contact the administrator or take other action to resolve the discrepancy. An intruder may abandon the intrusion since locks 212 and 214 are not unlocked.

When receiving a notice that the MAC address has been authenticated and a “home” setting was configured, in a state 1514 the controller 61 sets up the guard part 67 to the non-guard mode and unlocks the locks 212 and 214 in a state 1516. In a state 1518, the controller 61 notifies the management device 10 that the “home” set up has been completed for the apartment 210. After the state 1518, the controller 61 may indicate a message “unlock and non-guard mode completed” on the display (not shown).

Referring to FIG. 15, in a state 1606, the controller 11 of the management device 10 receives the message of completion of the “at home” setup via the transmitter/receiver 17, and changes the housing information to “absent” in the management table 15a.

Thereby, the locks 212 and 214 are unlocked and the guard mode is released. As shown in FIG. 1, the guard manager 60e is provided at the entrance or the like in the apartment 210 to restrict the admittance to the apartment 210. In this case, the controller 11 in the management device 10 allows the resident having the IC card 20 storing any one of the MAC addresses stored in the management table 15a to enter the apartment and change the guard mode.

As discussed above, according to the management system 1, the management device 10 performs a unitary management of the network for each network device 50 and admittance to the building 200. In addition, the management system 1 may assign different VLANs for respective network devices 50 based on their MAC addresses, thereby maintaining the high level of security for the network 100. The IC card 20 can perform the initial configuration for the network devices 50, improving the security in comparison with the conventional method. The network device 50 can be made unusable if the IC card 20 does not store its MAC address. Thereby, the network device 50 is protected from unauthorized users.

Further, the present invention is not limited to the preferred embodiment, and various variations and modifications may be made without departing from the scope of the present invention. The management system of the present invention is applicable, for example, to an office building, school, house, etc.

According to the inventive management device, method and system, the management device manages, based on the network information of the network device, not only the network but also the guard managers for managing apartments. Thereby, the management device performs a unitary management for the network and apartments, and thus provides comprehensive secured management for the apartment building, including multiple apartments. Therefore, this management system enhances the added and asset values of the apartment building.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A management system, comprising:
a managed device, located in a managed area, configured for connection to a network, wherein the managed device is assigned network information that enables the managed device to communicate over the network;
a guard manager, configured to guard the managed area against an intrusion; and
a management device, configured to manage the managed device using the network information, and configured to manage the guard manager.

2. The management system of claim 1, further comprising a plurality of managed areas, a plurality of managed devices, and a plurality of guard managers, wherein at least one managed device and at least one guard manager are located at each of the managed areas.

3. The management system of claim 1, further comprising a plurality of managed areas and a plurality of managed devices, wherein at least one managed device is located in each of the managed areas, wherein the plurality of managed areas comprise a closed space, and wherein the guard manager guards the closed space against an intrusion.

4. The management system of claim 1, wherein the network information is a MAC address of the managed device.

5. The management system of claim 1, wherein the network information is an IP address of the managed device.

6. The management system of claim 1, wherein the network information includes a communication parameter necessary for the managed device to communicate in the network, and wherein the network information includes device information that identifies the managed device.

7. The management system of claim 2, further comprising an interconnecting device configured to connect the managed devices and the management devices to the network, wherein the management device configures the interconnecting device such that a different virtual local area network (VLAN) is assigned to each managed area based on the network information of the managed devices.

8. The management system of claim 7, wherein the network information includes information of the VLAN.

9. The management system of claim 1, wherein the guard manager has a plurality of operational modes corresponding to a plurality of security levels for guarding the managed area, wherein the guard manager changes the operational mode in response to receiving the network information from an individual.

10. The management system of claim 1, further comprising an entrance server configured to provide the managed device access to the network using the network information.

11. The management system of claim 1, further comprising an interconnecting device configured to connect the managed device and the management device to the network, and configured to execute a predefined operation in accordance with information transferred by the guard manager to the management device.

12. The management system of claim 1, wherein the guard manager comprises a drive unit configured to read information from an information recordable medium, and wherein access to the managed area is authorized when the information read from the information recordable medium comprises the network information.

13. The management system of claim 12, wherein the information recordable medium is an integrated circuit card.

14. A management device configured to manage a managed device over a network, the management device comprising:
a storage part for storing network information of the managed device, wherein the network information allows the managed device to communicate over the network; and
a controller, configured to use the network information to control the managed device and a guard manager, wherein the guard manager is configured to control access to an area where the managed device is located.

15. The management device of claim 14, wherein the controller is further configured to control a connection status and traffic of the managed device.

16. The management device of claim 14, wherein the guard manager controls access to the managed area using the network information.

17. The management device of claim 14, wherein the controller authenticates the network information for use with the guard manager.

18. The management device of claim 14, wherein the guard manager sends information received from a person attempting to enter the managed area to the controller for authentication, wherein the controller provides an authentication status to the guard manager upon determining that the information sent from the guard manager corresponds to the network information stored in the storage part, and wherein the guard manager allows the person to access the managed area upon receiving the authentication from the controller.

19. The management device of claim 18, wherein the controller activates an alarm indicating that the information sent from the guard manager does not correspond to the network information stored in the storage part.

20. The management device of claim 14, wherein the controller activates an alarm, thereby informing a user of the management device of an intrusion to the managed area.

21. The management device of claim 14, wherein the controller disconnects the managed device from the network, when the guard manager informs the management device that a user of the managed device is away from the managed area.

22. A guard manager configured to guard a managed area containing a managed device, comprising:
a reader, configured to read information from an information recordable medium provided by a person requesting access to the managed area;
a transmitter, connected to the reader and configured to transmit information read by said reader to a management device; and
a controller, configured to provide access to the managed area in response to an instruction from the management device, wherein the management device sends the instruction to provide access when the information transmitted by the transmitter comprises network information assigned to the managed device.

23. The guard manager of claim 22, wherein the managed area has an entrance that opens and closes, and wherein the guard manager guards the managed area by locking and unlocking the entrance.

24. The guard manager of claim 22, further comprising a sensor configured to detect an intrusion upon the managed area, and wherein the guard manager informs the management device of any intrusion upon the managed area.

25. A method of managing a managed device and a managed area , wherein the managed device is configured for connection to a network and is located in the managed area, and wherein the managed device is assigned network information for communicating in the network, the method comprising:
determining whether information provided by a person requesting access to the managed area comprises the network information;
allowing the person to enter the managed area in response to determining that the information provided by the person comprises the network information; and
managing the managed device in the network using at least the network information.

26. The method of claim 25, wherein the information provided by the person is in the form of an information recordable medium, and wherein the method further comprises reading the information provided by the person from the information recordable medium.

27. The method of claim 25, wherein managing the managed device using at least the network information comprises controlling a connection status of the managed device to the network according to information provided by the guard manager.

28. A computer readable medium that includes a program executing a method of managing a managed device located in a managed area, the method comprising:
determining whether information provided by a person who requests access to the managed area comprises network information assigned to the managed device, wherein the network information enables the managed device to communicate over a network;
allowing the person to enter the managed area in response to determining that the information provided by the person comprises the network information; and
managing a status of the managed device in the network using the network information.

29. A method of controlling access to a managed area containing a device configured to connect to a network, the method comprising:
receiving information from a user at a location outside of the managed area;
processing the information so as to determine whether the information corresponds to network information assigned to the managed area;
allowing the user access to the managed area in response to determining a correspondence between the information received from the user and the network information; and
denying access to the managed area in response to determining the information received does not correspond to the network information.

30. The method of claim 29, wherein receiving information from a user further comprises reading the information from an information recordable medium.

31. The method of claim 29, wherein denying access to the managed area further comprises notifying the management device of an ungranted request for access to the managed area.

32. The method of claim 29, further comprising modifying a security level of the managed area according to status information received from the user at the location outside of the managed area.

33. The method of claim 32, wherein modifying a security level of the managed area comprises changing a network access status for the device according to the status information received from the user.

34. A system for controlling admittance to a managed area containing a device configured to connect to a network, the system comprising:
means for receiving information from a user at a location outside of the managed area;
means for processing the information received from the user so as to determine whether the information corresponds to network information assigned to the managed area;
means for allowing the user to access the managed area in response to determining a correspondence between the information received and the information assigned to the managed area; and
means for denying access to the managed area in response to determining the information received does not correspond to the network information.

35. The system of claim 34, wherein the means for receiving information from a user comprises means for reading the information from an information recordable medium.

36. The system of claim 34, wherein the means for denying access to the managed area comprises means for notifying the management device of an ungranted request for access to the managed area.

37. The system of claim 34, further comprising means for modifying a security level of the managed area according to status information received from the user at the location outside of the managed area.

38. A method of managing a device and a managed area, wherein the device is located in the managed area, and wherein the device is configured for connection to a network, the method comprising:
reading information from an information recordable medium at a location outside the managed area, wherein the information recordable medium is provided by a user;
comparing the information read from the information recordable medium with network information assigned to the device, wherein the network information enables the device to communicate over the network;
allowing the user to access the managed area and changing a security status of the managed area in response to determining a correspondence between the information read from the information recordable medium and the network information; and
denying the user access to the managed area and activating an alarm in response to determining no correspondence between the information read from the information recordable medium and the network information.

39. The method of claim 38, further comprising receiving information from the user at a location inside the managed area and changing a security status of the managed area in response to receiving the information from inside the managed area.

40. The method of claim 38, wherein allowing the user to change a security status of the managed area comprises changing a connection status of the managed device to the network in response to a security status instruction provided by the user.
